(19) United States
(12) Patent Application Publication
(10) Pub. No.: US 2014/0000406 A1
(43) Pub. Date: Jan. 2, 2014

(54) MANUAL PARKING BRAKE WITH AN OVER-CENTER HELPER SPRING

(71) Applicant: David Domkowski, Mainz (DE)

(72) Inventor: David Domkowski, Mainz (DE)

(73) Assignee: DAI NIPPON PRINTING CO.,, Tokyo (JP)

(21) Appl. No.: 13/877,611

(22) PCT Filed: Oct. 6, 2011
(86) PCT No.: PCT/EP2011/004979

§ 371 Date: Jul. 25, 2013

(30) Foreign Application Priority Data
Oct. 7, 2010 (DE) 10 2010 047 852.0

(51) Int. Cl. G05G 1/04

(52) U.S. Cl. CPC G05G 1/04
USPC 74/502.2

(57) ABSTRACT

A manual parking brake for a motor vehicle is provided. The manual parking brake includes a pivot-movably mounted hand brake lever and a cable sheave coupled to the hand brake lever. An over dead center spring is attached to an axis of rotation of the hand brake lever, which with the pivot-movably mounted hand brake lever in a rest position exerts a resetting force holding the pivot-movably mounted hand brake lever in this position and upon actuation of the pivot-movably mounted hand brake lever outputs a supporting force. A motor vehicle having such a manual parking brake also is provided.

### CROSS-REFERENCE TO RELATED APPLICATIONS

This application is a U.S. National-Stage entry under 35 U.S.C. §371 based on International Application No. PCT/EP2011/004979, filed Oct. 6, 2011 which was published under PCT Article 21(2) and which claims priority to German Application No. 10 2010 047 852.0, filed Oct. 7, 2010, which are all hereby incorporated in their entirety by reference.

### TECHNICAL FIELD

The technical field relates to a manual parking brake with an over dead center spring, in particular to a manual parking brake for a motor vehicle having an automatic readjusting device.

### BACKGROUND

Braking systems which are self-actuated manually using muscle power are usually described as manual parking brakes. In the case of the manual parking brakes which are used for motor vehicles, a hand brake lever is pivotably articulated rotatably about an axis in a basic bracket fastened to the vehicle body and connected in a rotationally secure manner to a part receiving a limited length of a brake cable. In addition, the hand brake lever is assigned a locking device, for locking the pulled manual parking brake into its active position and the released manual parking brake in the release position. This can be usually triggered by means of a spring-loaded push button arranged in the hand grip region of the hand brake lever and consists of a tooth segment arranged on the fixed bridge bracket which is curved concentrically to the articulation axis of the hand brake lever and a locking pawl interacting with the tooth segment which is pivotably mounted on the hand brake lever. Here, the push button is coupled to the locking pawl by a linkage arranged within the hand brake lever.

During the course of the operating duration, a certain elongation of the brake cable occurs with manual parking brakes of a motor vehicle in addition to a wear of the brake linings, as a result of which a backlash develops on the hand brake lever which becomes increasingly greater over the course of time, over the course of which backlash the cable elongation that has occurred is offset through an actuation of the handbrake lever. For this reason, a relatively frequent readjusting of the hand brake system is required in order to restrict the backlash of the hand brake lever to a predetermined dimension. A manual readjusting in this case is very difficult and frequently requires the complete exposing of the manual parking brake.

In the publication DE 38 20 978 A1 an automatic readjusting device is therefore proposed, wherein the cable sheave, which serves as guide element for the brake cable, is assigned a readjusting element which is independently rotatable of the cable sheave, which readjusting element on the one hand can be fixed in different rotation positions with respect to the fixed bridge bracket by means of a locking pawl and on the other hand interacts with the cable sheave via a stop arrangement in such a manner that the latter is always held in a rotation or starting position offsetting the undesirable backlash so that the backlash that manifests itself on the hand brake lever always remains restricted to a predetermined dimension.

From the publication DE 39 00 174 A1 an automatic readjusting device for a manual parking brake is known, wherein for the automatic offsetting of the elongation of the brake cable it is provided that the cable sheave is coupled to the hand brake lever by a pawl locking mechanism, wherein the coupling of the cable sheave to the hand brake lever is variable by the pawl locking device over a predetermined actuation angle range that goes beyond a permissible backlash resulting from a cable elongation, so that on exceeding a defined backlash the mutual relative position of hand brake lever and cable sheave is changed.

At least one object herein is to provide a manual parking brake for a motor vehicle that is configured efficiently and effectively and offers a better driving comfort. In addition, other objects, desirable features and characteristics will become apparent from the subsequent summary and detailed description, and the appended claims, taken in conjunction with the accompanying drawings and this background.

### SUMMARY

According to an embodiment, a motor vehicle manual parking brake that comprises a pivot-movably mounted hand brake lever, a cable sheave coupled to the latter and a locking device comprising a tooth segment arranged on a fixed bridge bracket of the vehicle body is provided. On an axis of rotation of the hand brake lever an over dead center spring is attached, which with the hand brake lever in the rest position exerts a resetting force holding the hand brake lever in this position and on actuating the hand brake lever outputs a supporting force.

For supporting the pivot movement and locking the hand brake lever, in order to hold it in the rest position, the hand brake lever is assigned an over dead center spring. Through the over dead center spring, an additional force to this end acts on the hand brake lever which has the initially rising then falling force curve over the increasing actuation travel that is typical for an over dead center spring, which is utilized here. By holding the hand brake lever in the rest position, the noise formation caused through the hand brake lever jumping while driving is thus avoided.

Furthermore, other spring elements in the manner of an over dead center spring can also be employed.

The manual parking brake in this case can comprise an automatic readjusting device. In the case of hand brake systems with an automatic readjusting device, the hand brake lever in rest position is mechanically decoupled from the hand brake cables, i.e. the pulling force is transmitted to the lever via the brake cables. This proves disadvantageous since the hand brake lever because of the free play resulting through the missing coupling can start to jump during driving, thereby causing rattling noises.

Because of the over dead center spring, such rattling noises are avoided since the hand brake lever is held in the rest position with the over dead center spring.

In addition, a counterforce for the distance up to the force coupling between the hand brake lever and the brake cables is generated through the over dead center spring. A missing coupling between hand brake lever and hand brake cables results in a distance which is required by the automatic readjusting device until the damping device integrated in the readjusting device grasps the brake cable and a connection between brake cable and hand brake lever is thus established. This distance, due to the transmission ratio, can amount to as much as 40 mm on the handle.

If no over dead center spring is provided, the driver can be imparted the sensation that the manual parking brake is no longer functional or worn. Over the over dead center spring the driver is thus not given the sensation that the manual parking brake no longer has any function or that it is worn.

In addition to this, the manual parking brake ensures a secure readjusting while avoiding frequent manual readjusting operations and in addition to this also a rapid adjustment of the manual parking brake following repair or assembly operations.

In an exemplary embodiment, the manual parking brake is a manual hand brake system. With the support of the inherent movement of the over dead center spring the driver in this case is enabled to securely park off his vehicle manually with little force expenditure. The pulling force to be exerted onto the hand brake lever by the driver for engaging the manual parking brake in this case is reduced, which results in a better driving comfort.

Furthermore, the over dead center spring can support itself for one part on the axis of rotation of the hand brake lever and for the other part on a component of the vehicle body arranged in a fixed manner. Through the above simple design measures, a rapid and cost-effective installation of the over dead center spring is ensured without complicated measures for the installation being required to do so. The spatial conditions in the vicinity of the axis of rotation of the hand brake lever are so restricted in many cases that an over dead center spring which satisfactorily operates in any way can otherwise be accommodated in this region only with difficulties.

Here, in an embodiment, the over dead center spring can be arranged in such a manner that it assumes its dead center position between the hand brake lever in rest position and a position of the hand brake lever, in which the latter is engaged in a first tooth of the tooth segment. A first tooth of the tooth segment in this case is to mean the tooth of the tooth segment in which the hand brake lever when actuated from the rest position engages first. The over dead center spring is thus arranged in such a manner that it is maximally compressed between the hand brake lever in rest position and a position of the hand brake lever in which the latter is engaged in a first tooth of the tooth segment and thus exerts its greatest possible force on the hand brake lever. The latter is thus pressed into the rest position as a result of which the free play of the non-actuated hand brake lever is substantially limited and because of this a jumping of the hand brake lever while driving is avoided. This results in an active, efficient noise reduction since rattling noises through a jumping hand brake lever are avoided and thus in turn in improved driving comfort.

In a further embodiment, the over dead center spring from exceeding the dead center position of the hand brake lever exerts a force which lowers the force to be exerted by a driver for actuating the hand brake lever. Following exceeding of the dead center, the active direction of the over dead center spring is reversed with simultaneously decreasing amount of the force. Here, the over dead center spring is thus arranged in such a manner that it exerts a force which acts supportingly in the direction of the pulling force to be exerted by the driver, so that the required absolute force expenditure of the driver for actuating the manual parking brake is substantially reduced in this region and the operating comfort thus improved. The absolute force expenditure to be exerted is thus obtained by subtracting the force exerted by the over dead center spring from the pulling force exerted by the driver.

Furthermore, the over dead center spring can have a force profile, which linearly joins the force expenditure to be exerted by the driver when actuating the hand brake lever. Subtracting the force exerted by the over dead center spring from the pulling force exerted by the driver thus results in an almost linear absolute force expenditure. From an ergonomical point of view, a linear force profile when actuating the hand brake lever and thus when engaging the manual parking brake proves to be pleasant and additionally comfortable compared with a non-linear force profile, which results in additionally improved comfort functions.

In another embodiment, a motor vehicle is also provided that comprises the manual parking brake described above.

A motor vehicle, which comprises the manual parking brake described above, has improved comfort functions. On the one hand the hand brake lever is thus pressed into and held in the rest position while driving through the over dead center spring, as a result of which the free play of the hand brake lever decoupled from the brake cables is limited and a jumping of the hand brake lever thus avoided, which can otherwise result in rattling noises. On the other hand, when the manual parking brake is provided with an automatic readjusting device, a counterforce is generated for the distance up to the force coupling between hand brake lever and the brake cables which imparts the driver the same feedback of the brake power as with manual brake systems without automatic readjusting device.

In summary it can be noted that with the various embodiments a manual parking brake for a motor vehicle is provided, which increases the driving comfort and operates efficiently and effectively at the same time. Owing to the fact that on the axis of rotation of the hand brake lever a over dead center spring is arranged, their typical force profile and inherent movement can be utilized. Initially, the spring has a rising force profile, as a result of which the hand brake lever can be held in the rest position, and a counterforce is generated at the same time for the distance up to the force coupling between hand brake lever and the brake cables when actuating the hand brake lever.

Here, the over dead center spring can be arranged in such a manner that it assumes its dead center position between the hand brake lever in rest position and a position of the hand brake lever, in which the lever is engaged in a first tooth of the tooth segment, i.e., is maximally compressed in this region. This results in that a force is exerted on the unactuated hand brake lever, which holds it in rest position and thus limits the free play of the hand brake lever while driving. Furthermore, the active direction of the force exerted by the over dead center spring reverses after the dead center is exceeded and is thus subtracted from the pulling force exerted by the driver when actuating the hand brake lever, as a result of which the absolute force expenditure is reduced. Since the over dead center spring has a force profile which when actuating the hand brake lever linearly joins the force expenditure to be exerted by the driver, an almost linear profile of the pulling force to be exerted by the driver when actuating the hand brake lever without irregularities is obtained, which from an ergonomical aspect can be perceived as unpleasant.

In this regard, rattling noises caused by a hand brake lever jumping while driving are avoided and the absolute force expenditure when actuating the hand brake lever to be exerted by the driver is reduced. For the distance up to the force coupling between hand brake lever and the brake cable of a manual parking brake for a motor vehicle with automatic readjusting device a counterforce is furthermore generated, which imparts the driver the same feedback of the brake power as with manual brake systems without automatic readjusting device.

### BRIEF DESCRIPTION OF THE DRAWINGS

The various embodiments will hereinafter be described in conjunction with the following drawing figures, wherein like numerals denote like elements, and wherein:

FIGS. 1A -D show schematic-perspective representations of a manual parking brake according to an embodiment;

FIG. 2 shows a schematic cross section of a part region of the manual parking brake of the embodiment shown in FIGS. 1A-D;

FIG. 3 shows a schematic-perspective representation of an over dead center spring with different compression lengths, according to the embodiment shown in FIGS. 1A-D; and

FIG. 4 shows a force-distance diagram for the force profile of the force exerted by the over dead center spring and for the force profile of the pulling force exerted by the driver when actuating the hand brake lever.

### DETAILED DESCRIPTION

The following detailed description is merely exemplary in nature and is not intended to limit the various embodiments or the application and uses thereof Furthermore, there is no intention to be bound by any theory presented in the preceding background or the following detailed description.

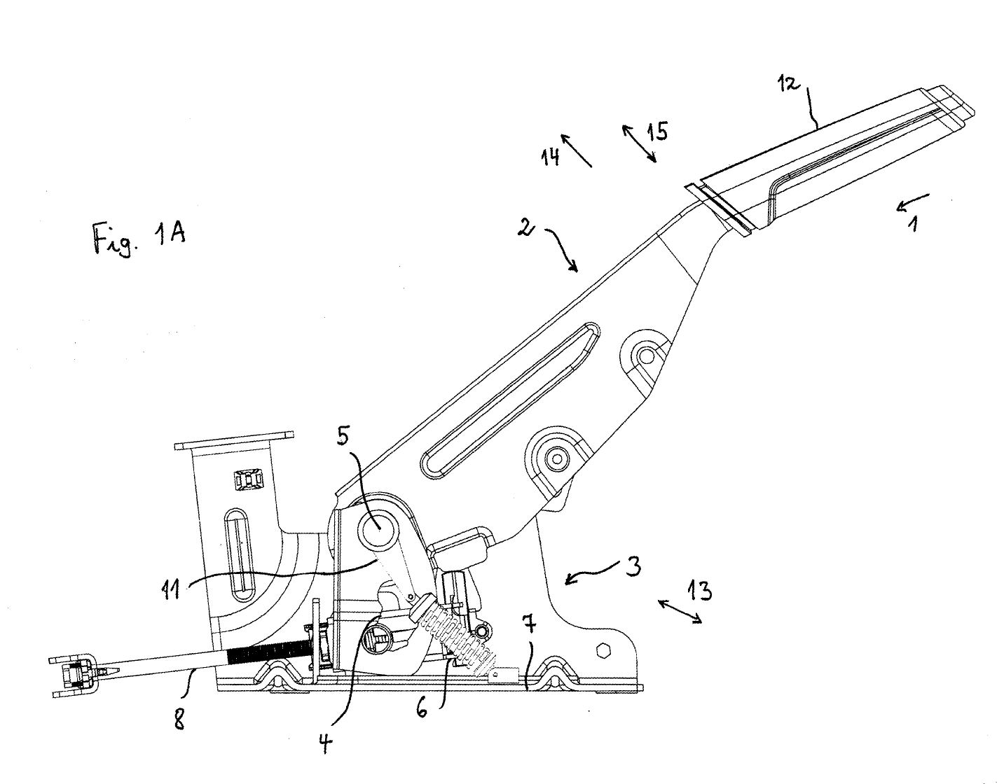

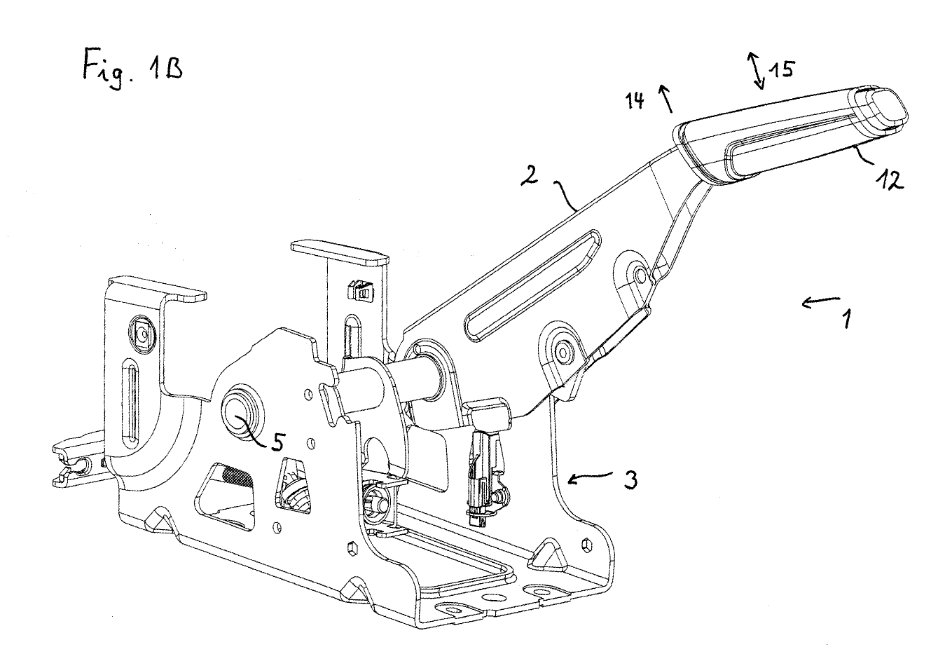

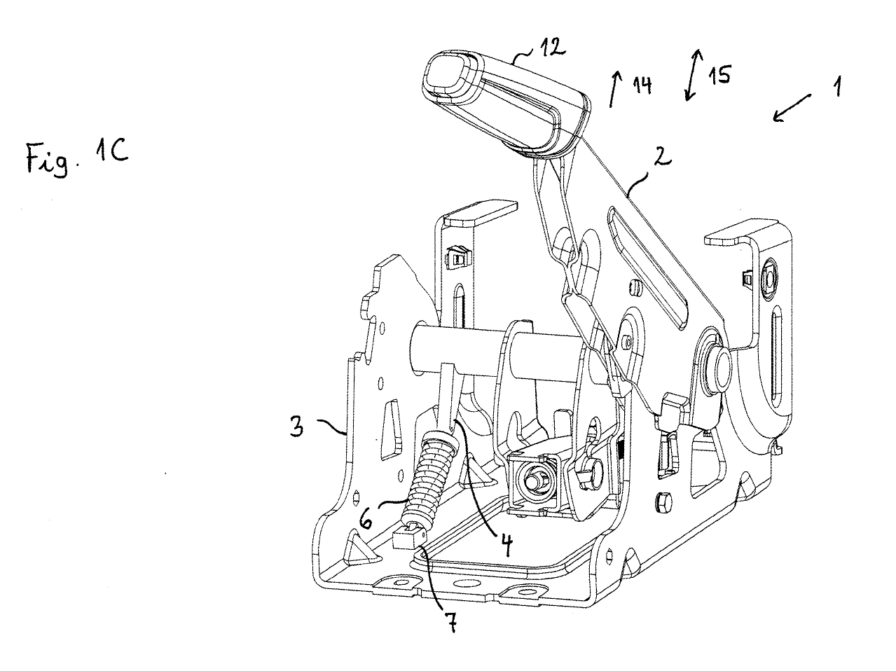

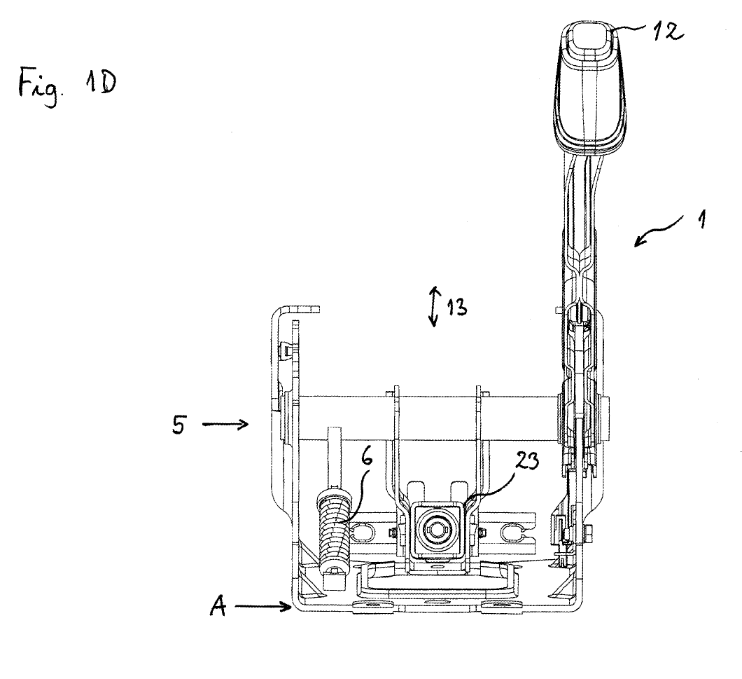

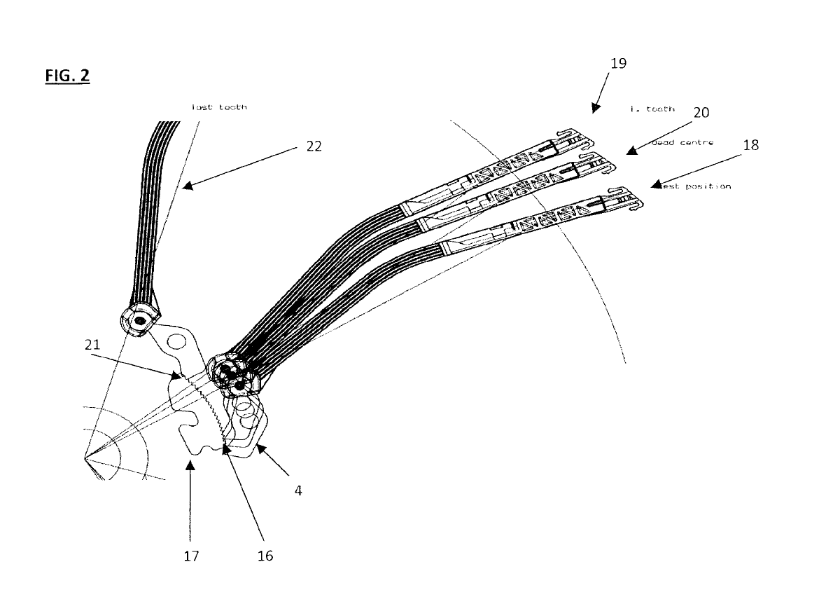

FIGS. 1A-D and 2 show in schematic representations a manual parking brake 1 in lateral view (FIG. 1A), oblique view of the hand brake lever 2 (FIG. 1B), in oblique view of the over dead center spring (FIG. 1C), from the front from the view of the driver (FIG. 1D) and in cross section a part region (FIG. 2), according to an embodiment.

FIG. 1A shows a schematic perspective lateral view of a manual parking brake 1 according to an embodiment.

Here, the manual parking brake 1 comprises a pivot-movably mounted hand brake lever 2, a cable sheave mounted with the latter, which serves as a guiding device for the brake cables, and a locking device 4 comprising a tooth segment arranged on a fixed bridge bracket of the vehicle body 3. Additionally noticeable is an over dead center spring 6 arranged on an axis of rotation of the hand brake lever 5.

Furthermore, other spring elements in the manner of an over dead center spring can also be employed.

In addition, the shown manual parking brake 1 comprises an automatic readjusting device. Here, FIG. 1A shows a cable actuator 8 communicating with the automatic readjusting device (not shown) which exerts an external force. Furthermore, known pneumatics or an electric motor can also be used.

Also noticeable is a control cable 11 of the brake system. The hand brake lever is also provided with a grip element 12, which is either arranged on the hand brake lever 2 in a fixed manner or for example is capable of being put on in order to be able to manually operate the manual parking brake 1.

The over dead center spring 6 in part supports itself on the axis of rotation or pivot axis of the hand brake lever 5 and for the other part on a component of the vehicle body 7 arranged in a fixed manner. The arrow provided with reference number 13 symbolizes the active direction of the force exerted on the hand brake lever 2 by the over dead center spring 6. By actuating the hand brake lever 2, the driver exerts a pulling force on the latter. The arrow marked with reference number 14 symbolizes the active direction of the pulling force. The arrow marked with reference number 15 in turn marks the movement direction of the hand brake lever 2.

FIG. 1B shows a schematic perspective oblique view of the manual parking brake 1 according to FIG. 1A on the hand brake lever 2.

Noticeable in turn is a hand brake lever 2 which is pivot-movably mounted about its axis of rotation 5. The hand brake lever 2 in turn is provided with a grip element 12, which is either arranged on the hand brake lever in a fixed manner or for example designed so it can be put on in order to be able to manually operate the manual parking brake 1. By actuating the hand brake lever 2, the driver exerts a pulling force on the latter, the active direction of which is symbolized by the arrow marked with reference number 14. Here, the arrow marked with reference number 15 characterizes the movement direction of the hand brake lever 2.

FIG. 1C shows a schematic perspective representation of the manual parking brake 1 according to FIG. 1A, from the front from the view of the driver.

As FIG. 1C shows, the manual parking brake 1 comprises a locking device for comprising a tooth segment arranged on a fixed bridge bracket of the vehicle body 3. Additionally noticeable is the over dead center spring 6 arranged on the axis of rotation of the hand brake lever 5.

Here, the over dead center spring 6 in part supports itself on the axis of rotation of the hand brake lever 5 and for the other part on a component of the vehicle body 7 arranged in a fixed manner. The arrow provided with reference number 13 in turn symbolizes the active direction of the force exerted by the over dead center spring 6 on the hand brake lever 2.

FIG. 1D shows a schematic perspective oblique view of the manual parking brake 1 according to FIG. 1A of the over dead center spring.

It is noticeable here that the shown manual parking brake 1 comprises an automatic readjusting device 23. Here, the latter communicates with a mechanical actuator 8 exerting an external force. Furthermore, known pneumatics or an electric motor can also be used.

As FIG. 1D shows, the manual parking brake 1 in this case additionally comprises a cable sheave coupled to the pivot-movably mounted hand brake lever 2, which serves as guiding device for the brake cables, and a locking device comprising a tooth segment arranged on a fixed bridge bracket of the vehicle body 3. Additionally noticeable is an over dead center spring 6 arranged on an axis of rotation of the hand brake lever 5.

FIG. 2 shows a schematic cross section of a part region of the manual parking brake 1 of the embodiment shown in FIGS. 1A-D.

The over dead center spring 6 is arranged in such a manner that it assumes its dead center position between the hand brake lever 2 in rest position, which is indicated by the reference number 18, and a position of the hand brake lever 2, in which the latter is engaged in a first tooth 16 of the tooth segment 17, which is indicated by the reference number 19. A first tooth 16 of the tooth segment 17 in this case is to mean the tooth 16 of the tooth segment 17 in which the hand brake lever 2 when actuated from the rest position engages first. The position of the hand brake lever 2 belonging to the dead center position of the over dead center spring 6 in this case is marked with the reference number 20. The over dead center spring 6 in this case is maximally compressed, exerts its greatest possible force on the hand brake lever 2, pushing the latter into its rest position 18.

On actuating the hand brake lever 2, the over dead center spring 6 exceeds its dead center position 20, as a result of which the direction of rotation of the force exerted by the over dead center spring 6 on the hand brake lever 2 reverses. The pulling force exerted by the driver through actuating the hand brake lever 2 and the force exerted by the over dead center spring 6 on the hand brake lever 2 act in the same directions, which results in that the absolute force expenditure to be exerted by the driver for actuating the hand brake lever 2 is lowered.

Furthermore, FIG. 2 shows the hand brake lever 2 in the position in which it is engaged in a last tooth 21 of the tooth segment 17. This is indicated by the reference number 22.

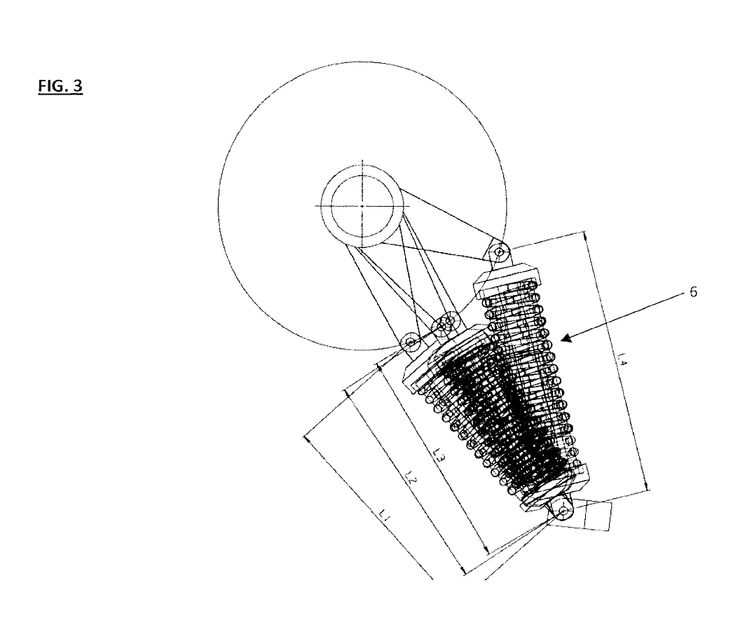

FIG. 3 shows a schematic perspective representation of an over dead center spring 6 with different compression lengths.

Here, the maximum compression of the over dead center spring 6 according to FIG. 3 is L2 mm, for example about 50.93 mm. In the rest position of the hand brake lever 20, the compression of the over dead center spring 6 is L1 mm and in the position 19, in which the hand brake lever 2 is engaged in a first tooth 16 of the tooth segment 17, L3 mm. Because of this, the hand brake lever 2 is held in rest position 18, as a result of which the free play of the hand brake lever 2 while driving is limited and a jumping of the hand brake lever 2 is avoided. Here, the value for L1 for example can be about 51.03 mm and the value for L3 for example can be about 51.13 mm.

In the position, in which the hand brake lever 2 is engaged in a last tooth 21 of the tooth segment 17, the compression of the over dead center spring 6 according to FIG. 3 is L4 mm, for example about 61.84 mm.

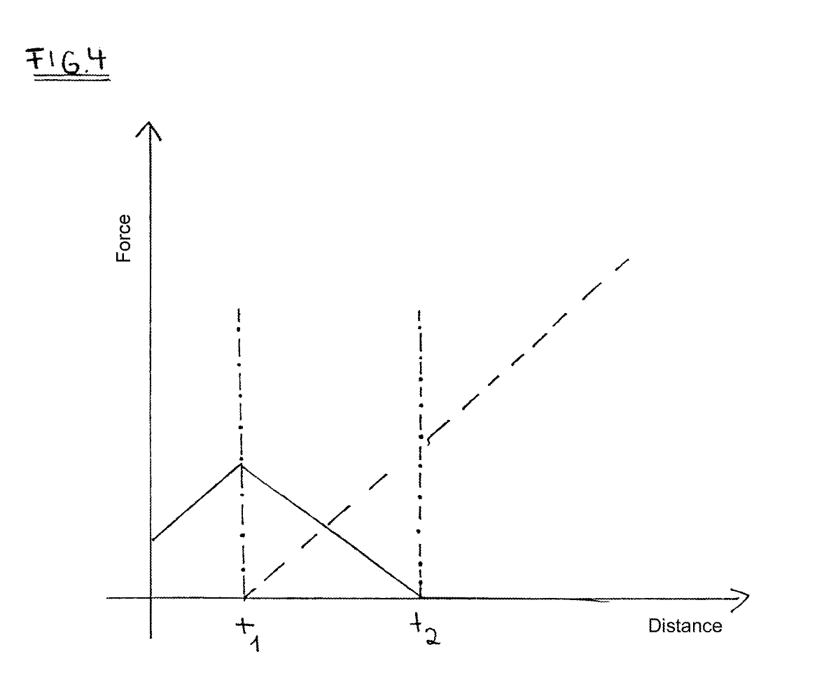

FIG. 4 shows a force-distance diagram for the force exerted by the over dead center spring 6 and for the pulling force exerted by the driver when actuating the hand brake lever 2.

From the diagram of FIG. 4, the force exerted by the over dead center spring 6 on the hand brake lever 2 and the pulling force exerted by the driver when actuating the hand brake lever 2 are plotted over the distance of the hand brake lever, wherein the starting position of the distance is the end position corresponding to the rest position of the hand brake lever 2. Here, the continuous line reflects the force exerted by the over dead center spring 6 on the hand brake lever 2 and the interrupted line the pulling force exerted by the driver when actuating the hand brake lever 2.

As shown by the diagram of FIG. 4, the force exerted by the over dead center spring 6 on the hand brake lever 2 commences immediately at the start of the actuating operation, while the pulling force on the hand brake lever 2 starts to act only after a certain time. This is due to the distance of the hand brake lever 2 required by the clamping device of the automatic readjusting device in order to grasp the brake cable.

As FIG. 4 shows, the force exerted by the over dead center spring 6 on the hand brake lever 2 initially rises linearly and reaches its maximum value at the time t1, in which the pulling force exerted by the driver starts to act on the hand brake lever. This corresponds to the dead center position of the over dead center spring 6, which the latter assumes between the hand brake lever 2 in rest position and a position of the hand brake lever 2, in which the latter is engaged in a first tooth of the tooth segment. Here, a first tooth of the tooth segment is to mean the tooth of the tooth segment in which the hand brake lever 2 engages first when actuated from the rest position. It is thus ensured that the hand brake lever 2 is held in rest position until the pulling force exerted by the driver starts to act.

From this time, the direction of the torque, which is exerted by the over dead center spring 6 and transmitted to the axis of rotation 5 of the hand brake lever 2 is reversed, and the force exerted by the over dead center spring starts to decrease linearly until the amount of the force from a time t2 finally is constantly equal to zero.

The pulling force exerted by the driver linearly increases from the time t1. The absolute force expenditure to be exerted by the driver for actuating the hand brake lever is thus obtained at any time t>t1 through subtracting the amount of the force exerted by the over dead center spring 6 on the hand brake lever 2 from the pulling force exerted by the driver by actuating the hand brake lever 2. Thus, the absolute force expenditure to be exerted by the driver for actuating the hand brake lever 2 is reduced.

FIG. 4 furthermore shows that the over dead center spring 6 in this case has a force profile which when actuating the hand brake lever 2 linearly joins the force expenditure to be exerted by the driver, which is perceived as pleasant since no irregularities in the absolute resultant force to be exerted by the driver for actuating the hand brake lever 2 occur.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

1. A manual parking brake for a motor vehicle, the manual parking brake comprising:
a pivot-movably mounted hand brake lever,
a cable sheave coupled to the pivot-movably mounted hand brake lever;
an over dead center spring attached to an axis of rotation of the pivot-movably mounted hand brake lever, which with the pivot-movably mounted hand brake lever in a rest position exerts a resetting force holding the pivot-movably mounted hand brake lever in this position and upon actuation of the pivot-movably mounted hand brake lever outputs a supporting force.

2. The manual parking brake according to claim 1, wherein the manual parking brake further comprises an automatic readjusting device.

3. The manual parking brake according to claim 1, further comprising a locking device comprising a tooth segment arranged on a fixed bridge bracket of the vehicle body.

4. The manual parking brake according to claim 1, wherein the over dead center spring in one part supports itself on an axis of rotation of the pivot-movably mounted hand brake lever and for another part on a component of the vehicle body arranged in a fixed manner.

5. The manual parking brake according to claim 4, wherein the over dead center spring is arranged in such a manner that it assumes a dead center position between the pivot-movably mounted hand brake lever in rest position and a position of the pivot-movably mounted hand brake lever in which the latter is engaged in a first tooth of a tooth segment.

6. The manual parking brake according to claim 5, wherein the over dead center spring from exceeding the dead center position loads the pivot-movably mounted hand brake lever with a force which lowers the pulling force to be exerted by a driver for actuating the pivot-movably mounted hand brake lever.

7. The manual parking brake according to claim 1, wherein a force exerted by the over dead center spring has a force profile which when actuating the pivot-movably mounted hand brake lever linearly joins a force expenditure to be exerted by a driver.

8. A motor vehicle having a manual parking brake comprising:
a pivot-movably mounted hand brake lever
a cable sheave coupled to the pivot-movably mounted hand brake lever; and
an over dead center spring attached to an axis of rotation of the pivot-movably mounted hand brake lever, which with the pivot-movably mounted hand brake lever in a rest position exerts a resetting force holding the pivot-movably mounted hand brake lever in this position and upon actuation of the pivot-movably mounted hand brake lever outputs a supporting force.

9. The motor vehicle according to claim 8, wherein the manual parking brake further comprises an automatic readjusting device.

10. The motor vehicle according to claim 8, wherein the over dead center spring in one part supports itself on an axis of rotation of the pivot-movably mounted hand brake lever and for another part on a component of the vehicle body arranged in a fixed manner.

11. The motor vehicle according to claim 8, wherein the over dead center spring is arranged in such a manner that it assumes a dead center position between the pivot-movably mounted hand brake lever in rest position and a position of the pivot-movably mounted hand brake lever in which the latter is engaged in a first tooth of a tooth segment.

12. The motor vehicle according to claim 11, wherein the over dead center spring from exceeding the dead center position loads the pivot-movably mounted hand brake lever with a force which lowers the pulling force to be exerted by a driver for actuating the pivot-movably mounted hand brake lever.

13. The motor vehicle according to claim 8, wherein a force exerted by the over dead center spring has a force profile which when actuating the pivot-movably mounted hand brake lever linearly joins a force expenditure to be exerted by a driver.

14. The manual parking brake according to claim 8, further comprising a locking device comprising a tooth segment arranged on a fixed bridge bracket of the vehicle body.
